(19) United States
(12) Patent Application Publication
(10) Pub. No.: US 2008/0263115 A1
(43) Pub. Date: Oct. 23, 2008

(54) Very long arithmetic logic unit for security processor

(75) Inventors: Tomer Y. Morad, Tel-Aviv (IL); Ami Hazbany, RaAnana (IL)

Correspondence Address: Martin D. Moynihan;PRTSI, Inc., P.O. Box 16446, Arlington, VA, 22215, US

(73) Assignee: Horizon Semiconductors Ltd., Herzlia (IL)

(21) Appl. No.: 11/785,363

(22) Filed: Apr. 17, 2007

(51) Int. Cl. G06F 7/575; G06F 7/38

(52) U.S. Cl. 708/230; 708/604

(57) ABSTRACT

An arithmetic and logic unit carries out arithmetic or logic operations on long operands. The unit comprises: an operation unit having a processing location, and configured for carrying out processing on bits at the processing location, the processing comprising any of a plurality of pre-defined arithmetic or logical operations, the processes being defined for a first number of bits determined by the operand word length; a fetch and write unit comprising direct memory access circuitry for fetching a second number of bits of operand data by direct access from an external memory and for writing results to memory, the second number being set by a predetermined memory access width; the second number being smaller than said operand word length, and the direct memory access circuitry being configured to deliver said second number of bits directly to the processing location without aggregation prior to processing. The fetch and write unit is controllable to carry out fetch operations for a further second number of bits of the long operand while a current part of the operand is being processed in said operation unit, thereby to hide memory access latency.

### FIELD AND BACKGROUND OF THE INVENTION

The present invention relates to processors for carrying out encryption and decryption operations that require long length operands. In particular the processors are for communication systems and more exclusively but not explicitly for cable set-top boxes, satellite set-top boxes, DTVs, modems and home gateways, which are increasingly required to encrypt and decrypt data using symmetric and asymmetric ciphers that are based on such long length operands.

The devices above, hereinafter set top boxes or STBs, are used to receive data from cable or satellite links, from a home network, digital still or video cameras, or any other kind of network device. The STB may also send data to the home network, digital still or video camera, or any kind of network device. The data includes a number of compressed & uncompressed video, audio, still image & data channels, and may be either scrambled or unscrambled.

Public key cryptography is a form of cryptography which generally allows users to communicate securely without having prior access to a shared secret key. This is done by using a pair of cryptographic keys, designated as public key and private key, which are related mathematically. What has been encrypted by the first key, can only be decrypted by the second—and vice versa.

In public key cryptography, the private key is kept secret, while the public key may be widely distributed. In a sense, one key “locks” the message; while the other is required to unlock the message. It should not be feasible to deduce the private key of a pair given the public key, and in high quality algorithms no such technique is known.

There are a number of ways in which public key systems may be used, including:
public key encryption—the message may be encoded by anyone with the public key but is kept secret from anyone who does not possess the specific private key.
public key digital signature—allowing anyone with the public key to verify that a message was created with the corresponding private key.
key agreement—the public key allows one to securely share with others a secret key for another enciphering system. Thus two parties that may not initially share a secret key may agree on such a secret key without any exposure of the secret key to eavesdroppers.

Typically, public key techniques are much more computationally intensive than purely symmetric algorithms, but the judicious use of these techniques enables a wide variety of applications. In particular, key agreement means that the computationally intensive public key technique is only used to a minimal extent at the start of the transaction and less demanding techniques can be used later on.

Authentication between network devices is usually done using asymmetric ciphers, in which a symmetric encryption key is generated and exchanged via a secure channel.

RSA is one well-known and widely used algorithm for public-key encryption. RSA is widely used in electronic commerce protocols, and is believed to be secure given sufficiently long keys. The security of the RSA cryptosystem is based on two mathematical problems: the problem of factoring large numbers and the RSA problem. The RSA problem is defined as the task of taking e^{th} roots modulo a composite n: recovering a value m such that m^{e}=c mod n, where (e, n) is an RSA public key and c is an RSA ciphertext. Currently the most promising approach to solving the RSA problem is to factor the modulus n. RSA keys are typically 1024-2048 bits long. It is generally presumed that RSA is secure if n is sufficiently large.

The skilled in the art may appreciate that the computational task for ciphering and de-ciphering symmetric/asymmetric cryptology based messages necessitates an efficient processing unit. Preferably such a device should be able to execute the necessary tasks in real time.

A known general purpose microcontroller architecture, which is well described in the art, is considered for the implementation of encryption/decryption algorithms. Such a known microcontroller may contain multiple CPUs & ALUs, each or all are implemented on a single silicon die.

As described in the art, a general purpose microprocessor (sometimes abbreviated μP) is a programmable digital electronic component that incorporates the functions of a central processing unit (CPU) on a single integrated circuit (IC). The arithmetic logic unit (ALU) is a digital circuit that calculates an arithmetic operation (such as an addition, subtraction, etc.) and logic operations (such as an Exclusive Or) between two numbers. The ALU is a fundamental building block of the central processing unit of a computer. Modern general purpose microprocessors incorporate complex ALUs. These ALUs can perform most 32 or 64 bit operations in a single cycle.

Long arithmetic operations, such as required in asymmetric encryption and decryption, are composed of multiple shift/add/divide procedures, which are repeated over & over, each time producing partial results and a carry. An implementation of an encryption algorithm, such as RSA, on a general purpose microcontroller involves complex data supply software (multiple fetch/store operations) and thus results in low utilization of the ALU resources. Therefore, a general purpose processor is not adequate for these types of calculations in performance constrained environments. Those skilled in the art may appreciate that the implementation of complex encryption/decryption algorithms over a general purpose CPU, suffers from low throughput and inefficient memory bandwidth. Additionally, such implementation, when performing long arithmetic instructions, occupies the CPU resources, and thus the CPU may not be used for other tasks. An additional disadvantage of such an implementation is the high cost of integration, software development, qualification, time to market etc. Another drawback is the high power dissipation, low fault tolerance and short life time (MTBF). On top of that, software implementations are susceptible to a potential security breach through so-called “side channel attack” which is a method of breaking secure systems and recovering secrets through power consumption analysis of microprocessor-based ciphers.

As a consequence, such operations are implemented in hardware using specialized ALU units that are specifically designed for the extra long operand length. However such devices still give rise to large memory access bandwidth.

### SUMMARY OF THE INVENTION

According to one aspect of the present invention there is provided an arithmetic and logic unit for carrying out arithmetic or logic operations on long operands, said long operands having an operand word length, the unit comprising:

an operation unit comprising circuitry for carrying out selectable ones of a plurality of pre-defined arithmetic or logical operations on a first number of bits determined by said operand word length;

a fetch and write unit comprising direct memory access circuitry for fetching a second number of bits of operand data by direct access from an external memory and for writing results to memory, said second number being set by a predetermined memory access width;

said second number being smaller than an operand length, and said fetch and write unit being controllable to carry out fetch operations for a further second number of bits of a long operand while a current part of said operand is being processed in said operation unit, thereby to hide memory access latency.

According to a second aspect of the present invention there is provided a multi-word arithmetic device for executing modular arithmetic on multi-word integers, in accordance with instructions from an external device, the multi-word arithmetic device comprising:
a memory;
an arithmetic unit for executing, on word units, at least four types of word calculations, including addition, subtraction, multiplication, comparison and shifting, and outputting a one-word calculation result;
a memory input/output circuit for performing (1) a first data transfer for storing in the memory at least one integer received from an external device, (2) a second data transfer for inputting at least one integer stored in the memory into the arithmetic unit in word units, (3) a third data transfer for storing in the memory the calculation result output from the arithmetic unit, and (4) a fourth data transfer for outputting the calculation result from the memory to the external device; and
a control circuit for, according to instructions received from the external device,
(a) specifying, to the memory input/output unit, data to be transferred by the second and third data transfers, and
(b) specifying, to the arithmetic unit, a type of word calculation to be executed,
thereby controlling:
(i) the arithmetic unit to selectively perform one of said at least four types of calculations, including addition, subtraction, multiplication and division, on the at least one integer stored in the memory; and
(ii) the memory input/output circuit to store the calculation result of the calculations into the memory,
wherein the selected modular arithmetic includes a plurality of word calculations, each word calculation for a different word of the at least one integer;
the control circuit being configured such that when the selected modular arithmetic is performed, the control circuit repeatedly instructs, for each word of the at least one integer, the arithmetic unit to perform the word calculation, wherein, when receiving an instruction to execute calculations from the external device, the control circuit controls the memory input/output circuit and the arithmetic unit so as to execute the following processing:
(1) the memory input/output circuit acquires the operands for the calculations from memory;
(2) the arithmetic unit computes partial results for words from each of (i) parts of the operands, and (ii) the result integer;
(3) the memory input/output circuit stores the result of (2) in memory.
According to a third aspect of the present invention there is provided an arithmetic and logic unit for carrying out arithmetic or logic operations on long operands having an operand word length, the unit comprising:

an operation unit comprising a processing location, the operational unit being configured for carrying out processing on bits at said processing location, the processing comprising selectable ones of a plurality of pre-defined arithmetic or logical operations, the processes being defined for a first number of bits determined by said operand word length;

a fetch and write unit comprising direct memory access circuitry for fetching a second number of bits of operand data by direct access from an external memory and for writing results to memory, said second number being set by a predetermined memory access width;

said second number being smaller than or equal to said first predetermined number, and said direct memory access circuitry being configured to deliver said second number of bits directly to said processing location.

According to a fourth aspect of the present invention there is provided an arithmetic and logic unit for carrying out arithmetic or logic operations on long operands having an operand word length, the unit comprising:

an operation unit comprising a processing location, the operational unit being configured for carrying out processing on bits at said processing location, the processing comprising selectable ones of a plurality of pre-defined arithmetic or logical operations, the processes being defined for a first number of bits determined by said operand word length;

a fetch and write unit comprising direct memory access circuitry for fetching a second number of bits of operand data by direct access from an external memory and for writing results to memory, said second number being set by a predetermined memory access width and being smaller than said first number;

and wherein said operation unit comprises a dedicated register for each one of said plurality of predefined arithmetic or logical operations, thereby to allow more than one of said plurality of predefined arithmetic or logical operations to be carried out in parallel.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a schematic illustration of the very long arithmetic logic unit (VLALU) device 100, in accordance with one embodiment of the invention;

FIG. 2 schematically illustrates the location of three operands, a, b and c, in a certain memory structure, in accordance with one embodiment of the invention;

FIG. 3 is a schematic illustration of the internal structure of the VLALU device 100, in accordance with one embodiment of the invention;

FIG. 4 schematically illustrates the multiplier's operands, divided into sub-blocks, in accordance with one embodiment of the invention;

FIG. 5 schematically illustrates the divider's operands, X, D, R and Q, in accordance with one embodiment of the invention;

FIG. 6 schematically illustrates an example multiplication of two 64 bit operands, when the memory width is 32 bits and the multiplier's width is 16; and

FIG. 7 schematically illustrates an example calculation of 73 divided by 3.

### DESCRIPTION OF THE PREFERRED EMBODIMENTS

The present embodiments comprise a system and a method for performing long operand arithmetic calculations of the kind required by public key and asymmetric ciphers, and the implementation of a Very Long Data Word Arithmetic Logic Unit (VLALU), hereinafter VLALU, for a Security Processor device. These ciphers include, but are not limited to, RSA, Eliptic Curve Cryptography, and ACE.

The present embodiments may use direct memory access by the very long data word ALU unit, and may further use processing time to hide memory latency.

The principles and operation of a system and method according to the present invention may be better understood with reference to the drawings and accompanying description.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. In addition, it is to be understood that the phraseology and terminology employed herein is for the purpose of description and should not be regarded as limiting.

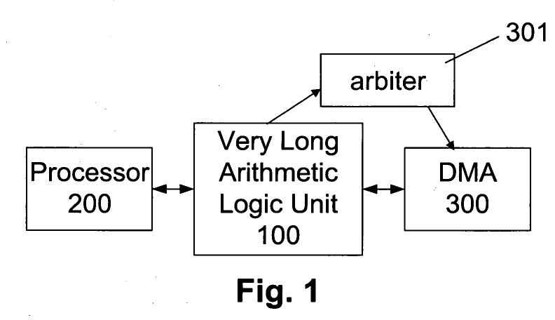

Reference is now made to FIG. 1, which shows a very long arithmetic and logic unit 100, in accordance with a preferred embodiment of the present invention. The unit comprises a processor or operating unit 200, and direct memory access or fetch and write unit 300. The arithmetic and logic unit 100 carries out arithmetic or logic operations on long operands, and the long operands have an operand word length which is suitable for operations with public key cryptosystems. Thus for example it is suitable for RSA-type calculations.

The operation unit 200 comprises circuitry for carrying out any of several pre-defined arithmetic or logical operations on a first number of bits determined by the operand word length. The first number of bits is preferably smaller than the operand word length but a multiple of the number of bits fetched by the individual fetch operation.

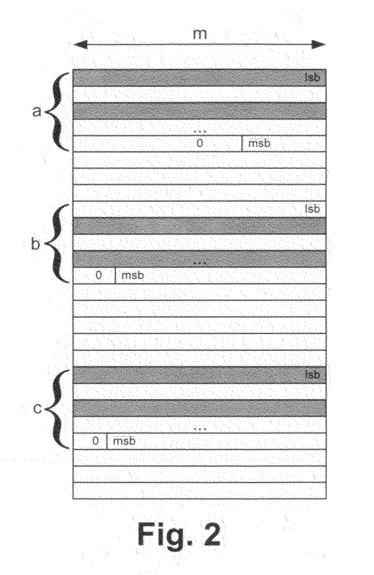

The DMA unit 300 is a fetch and write unit which comprises direct memory access circuitry for fetching a second number of bits of operand data by direct access from an external memory and for writing results to memory. The second number is the number of bits that can be obtained in a single fetch instruction, and is typically set by the memory access width, that is by the number of bits that can be fetched in a single instruction from the memory. The memory access width is defined by the width of the system bus, the memory architecture and the definition of the fetch instruction. FIG. 2 illustrates a memory structure in which long word operands a, b, and c are stored. The word length from least to most significant bits is considerably longer than the memory width m. The memory width is the number of bits typically delivered in a single fetch operation.

The second number is smaller than the operand length for any practical computational device. As explained in the introduction, in some prior art systems multiple fetches may be carried out until the entire operand is present, and only then can the calculation begin. Such a procedure however takes time and secondly, sufficient register space is required on the unit for storing the entire operand, thus increasing the amount of expensive real estate on the chip needed by unit 100. The present embodiments operate on parts of the operand at a time, and generate partial results and carries. The rest of the result is produced when the remainder of the operand arrives. Thus register space is saved on the unit 100 since at no time is the entire operand stored on the unit. In an embodiment the partial results are placed back in the memory after processing so that the complete result is also never stored on the unit.

The fetch and write unit is free to carry out additional fetch operations for a further second number of bits of a long operand while a current part of the operand is being processed in the operation unit. As a result fetching and processing are carried out in parallel and the memory access latency is hidden.

Likewise the results, as produced, may be stored directly back into the memory, again by direct memory access. Storage of results in the memory saves register space on the chip, and memory latency is hidden by carrying out the storage operation at the same time as generation of the next part result.

In one embodiment the number of bits fetched in a single operation, the second predetermined number, is the number of bits that is processed each time. In another embodiment the first predetermined number is selected for operation so that the time required for the arithmetic or logical operations is greater than or, even more preferably just large enough, to mask the time required for memory fetch and write operations. As a result the memory latency is most effectively hidden.

Preferably, the first number is selected to optimize between chip area utilization, the time required for fetch and write operations, and power utilization. The larger the first number the more bits are processed in parallel so the larger the processor has to be, thus using more power. Also the more fetch operations are needed to feed the processor with enough bits to operate and the longer the operations themselves take. Longer operations may imply multi-cycle operations or lengthening of the clock cycle. Lengthening of the clock cycle slows the entire chip down. A smaller first number means that fewer memory fetches are needed and each operation is quicker, but more operations are needed overall to cover the entire operand.

In one case the operation is addition and the fetch and write unit is controllable in the case of addition to fetch each second predetermined number of bits of a current operand prior to processing, and there are two or more prefetch registers each to store a part of the operand from a single fetch until required for processing. At no point is the entire operand stored however.

In another case the operation is multiplication, and the fetch and write unit is controllable to fetch the second predetermined number of bits of each of two multiplication operands, and to complete multiplication sub-operations on all bits of one of the two multiplication operands before fetching new bits of the other of the two multiplication operands.

Other cases are division and modulus operations.

In one embodiment the unit 100 comprises a single temporary register which is shared between all of the operations. In this case it is not possible to carry out two different operations in parallel. However in another embodiment each operation has its own dedicated temporary register. Different operations may therefore be carried out at the same unit 100 in parallel, at the cost of slightly increased chip utilization space. In this case there may be conflicts between the operations for use of the DMA unit 300. There is therefore provided a direct memory access arbiter 301 for arbitrating between operations to dynamically assign direct memory access between the operations and thus avoid bus conflict.

In one aspect of the invention the bits fetched are placed directly at a processing register or in a prefetch register to wait for further fetch operations to be completed so that sufficient bits are available for processing. However at no point is the entire operand stored.

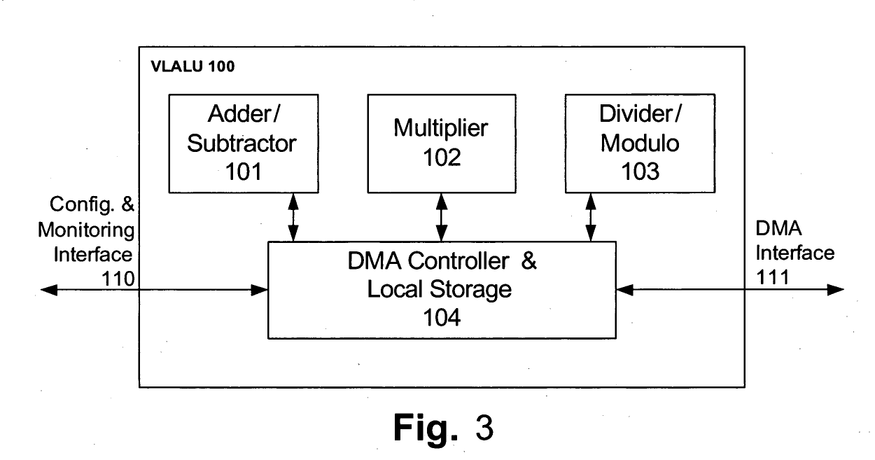

Reference is made to FIG. 3, which is a simplified block diagram of VLALU 100 according to a preferred embodiment of the present invention. The VLALU device 100 comprises an Adder/Subtractor unit 101, Multiplier unit 102, Divider/Modulo unit 103, and DMA controller and local storage unit 104.

The VLALU device 100 further comprises configuration and monitoring interface 110, and direct memory access (DMA) interface 111. The VLALU device 100 can operate independently. Alternatively, an external controller may use the Configuration and Status interface 110 to configure the VLALU device 100, and to monitor its status.

As discussed earlier, long arithmetic operations are typically used for the implementation of symmetric/asymmetric encryption and decryption. In particular, the following five basic operations are used: addition, subtraction, multiplication, division and modulo.

### Addition Operation

2's complement addition operation is performed iteratively on smaller parts of the operands. The sum is then derived from concatenating all the intermediate additions, in the following manner:

First, the two 2's compliment representation of the operands (a, b) are divided into nk sub-blocks of one bit each, as follows:

a={aₙₖ₋₁, . . . , a₂, a₁, a₀}

b={bₙₖ₋₁, . . . , b₂, b₁, b₀}

The operands can also be represented by n sub-blocks, each with k bits, as follows:

a⁽ⁱ⁾={a₍ᵢ₊₁₎ₖ₋₁, . . . , aᵢₖ}

b⁽ⁱ⁾={b₍ᵢ₊₁₎ₖ₋₁, . . . , bᵢₖ}

For simplicity, m/k (the width of the memory divided by the size of the operands) is assumed to be an integer. The constant k preferably reflects the maximum number of bits allowed in the Adder/Subtractor unit 101. High values of k result in higher performance per cycle, since the calculations are performed on more bits simultaneously. Lower values of k result in a smaller area taken up by the unit on the chip and lower delay of the operation as a whole. That is to say the resulting addition process takes less time since there are fewer bit positions for the addition to propagate through, but the end result covers less of the operand and so needs to be carried out more often per operand.

The number of sub-blocks n is calculated by dividing the total number of bits in the operands by the number of bits of the adder, k. If the division does not result in an integer, the result is rounded up to the nearest integer.

The addition is performed by calculating the following formula for each sub-block i, starting at i=0 and c₀=0:

{cᵢ₊₁,s⁽ⁱ⁾}=a⁽ⁱ⁾+b⁽ⁱ⁾+cᵢ

The intermediate result is stored in a temporary register t, whose width is (m+1) bits. Exactly m/k intermediate results are required to fill the register t. Each addition uses the carry bit generated by the previous addition iteration. Following m/k additions, the least significant m bits of t are written to memory. The most significant bit of t is the carry bit for the next addition.

When used in conjunction with the DMA controller 104, the adder requires two read operations of m bits to two operand registers, one write operation of m bits for the result, and m/k additions for every m/k sub-blocks. By varying m, an optimal trade-off between memory access overhead, silicon area and power consumption can be reached. Therefore, the performance (bits per cycle) of the addition command is as follows:

$${Perf}_{bits / cycle} = \frac{m}{2 {latency}_{read} + {latency}_{write} + ⌈ m / k ⌉}$$

In one of the preferred embodiments of the invention, DMA may be used to prefetch the operands prior to their use. This would require at least two shadow registers, each of m bits in size. The shadow registers are also referred to herein as prefetch registers. The benefit from prefetching the operands is the ability to reach full utilization for the adder, in that calculations may proceed on one part of the operand while another part is being fetched. The performance is thus:

$${Perf}_{bits / cycle} = k , if ( 2 {latency}_{read} + {latency}_{write} < ⌈ m / k ⌉ )$$

A general purpose processor would achieve much lower performance, due to the data supply overhead. Each k-bit operation requires at least two load instructions, one add operation, one store operation, three instructions for updating the memory pointers and two instructions for flow control. If all of the instructions take only one cycle to complete, the resulting performance is:

$${Perf}_{bits / cycle , general purpose} = \frac{k}{2 + 1 + 1 + 3 + 2} = \frac{k}{9}$$

The following example shows the mathematical operation of the adder:

k=2;m=4;a=12h;b=36 h

a⁽²⁾=1;a⁽¹⁾=0;a⁽⁰⁾=2

b⁽²⁾=3;b⁽¹⁾=1;b⁽⁰⁾=2

{c₁,s⁽⁰⁾}=2+2+0=4={c₁=1,s⁽⁰⁾=0}

{c₂,s⁽¹⁾}=0+1+=2={c₂=0,s⁽¹⁾=2}

{c₃,s⁽²⁾}=1+3+0=4={c₃=1,s⁽²⁾=0}

{c₄,s⁽³⁾}=0+0+1=1={c₄=0,s⁽³⁾=1}

s=a+b=1·2⁶+0·2⁴+2·2²+0·2⁰=64+8=48h

Herein, “h” indicates use of hexadecimal notation.

### Subtraction Operation

2's complement subtraction operation is performed in substantially similar manner as the addition operation is performed, with the following changes:

{cᵢ₊₁,s⁽ⁱ⁾}=a⁽ⁱ⁾+ b̅⁽̅ⁱ̅⁾̅+cᵢ

c₀=1

Where b̅(̅i̅)̅ is the bitwise inversion of b⁽ⁱ⁾.

The following example shows the mathematical operation of the subtractor:

k=2;m=4;a=48h;b=12h

a⁽³⁾=1;a⁽²⁾=0;a⁽¹⁾=2;a⁽⁰⁾=0

b⁽³⁾=0;b⁽²⁾=1;b⁽¹⁾=0;b⁽⁰⁾=2

b̅⁽³⁾=3; b̅⁽²⁾=2; b̅⁽¹⁾=3; b̅⁽⁰⁾=1

{c₁,s⁽⁰⁾}=0+1+1=2={c₁=0,s⁽⁰⁾=2}

{c₂,s⁽¹⁾}=2+3+0=5={c₂=1,s⁽¹⁾=1}

{c₃,s⁽²⁾}=0+2+1=3={c₃=0,s⁽²⁾=3}

{c₄,s⁽³⁾}=1+3+0=4={c₄=1,s⁽³⁾=0}

s=a−b=0·2⁶+3·2⁴+1·2²+2·2⁰=48+4+2=36h

### Multiplication Operation

2's complement multiplication operation of two large numbers can be a complex and time consuming task. The VLALU implements the multiplication operation by using an undersized operand multiplier iteratively. In one embodiment of the invention, the multiplier may multiply k by l bits. In the preferred embodiment of the invention, the multiplier is symmetric, and may multiply k bits by k bits, resulting in a 2 k bit product. In the preferred embodiment, the multiplication operation is performed in the following manner:

First, the two operands are divided into n sub-blocks of m bits as following:

a≡{aₙₘ₋₁, . . . , a₂, a₁, a₀}

b≡{bₙₘ₋₁, . . . , b₂, b₁, b₀}

a⁽ⁱ⁾≡{a₍ᵢ₊₁₎ₘ₋₁, . . . , aᵢₘ}

b⁽ⁱ⁾≡{b₍ᵢ₊₁₎ₘ₋₁, . . . , bᵢₘ}

a^{%(i)}≡{a₍ᵢ₊₁₎ₖ₋₁, . . . , aᵢₖ}

b^{%(i)}≡{b₍ᵢ₊₁₎ₖ₋₁, . . . , bᵢₖ}

The constant k preferably reflects the maximum number of bits allowed for the multiplier of the Multiplier unit 102. High values of k result in higher performance per cycle, whereas lower values of k result in smaller area and lower delay. That is to say, as with the adder, smaller parts of the operand are taken so that each operation is quicker but more operations are required.

The number of sub-blocks n, is calculated by dividing the total number of bits in the operands by the memory width, m. If the division does not result in an integer, the result is rounded up to the nearest integer.

The calculation starts by setting the 2 nm-bit product result in memory to zero. Then, the multiplication is performed by calculating the following formula for each m-bit sub-block i, j, starting at i=j=0:

p^{(i)(j)}=a⁽ⁱ⁾b^{(j)}

Calculating p^{(i)(j)} involves first reading the two m-bit operands a^{(j)} and b⁽ⁱ⁾ from memory to two m-bit temporary registers. Then, the operands are multiplied using a k-bit multiplier iteratively. Each temporary 2 k-bit result is added to a 2 m-bit temporary register, that holds p^{(i)(j)}. Finally, the 2 m-bit result is added to the 2 nm-bit multiplication result in memory. p^{(i)(j)} is calculated for all possible values of i and j. In order to reduce the number of reads for the m-bit operands, all values of i are traversed before another value of j is used. This is similar to a nested “for” loop in the “C” programming language, where i is the counter of the inner loop, and j is the counter of the outer loop.

Multiplying two m-bit operands is performed using a k-bit multiplier iteratively. The m-bit operands a^{(j)} and b⁽ⁱ⁾ are divided again into smaller k-bit operands:

$${a}_{l}^{( i )} ≡ {a}^{{\%}^{( i \frac{m}{k} + l )}}$$

$${b}_{l}^{( i )} ≡ {b}^{{\%}^{( i \frac{m}{k} + l )}}$$

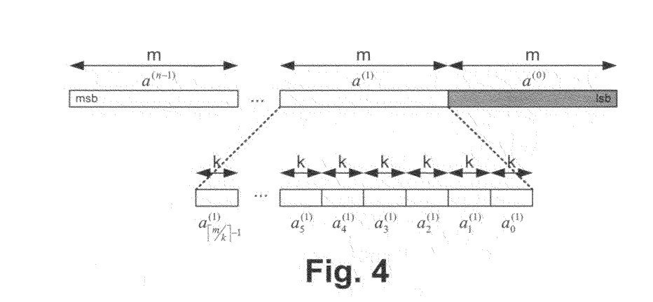

Reference is made to FIG. 4, which is a simplified schematic diagram illustrating the sub-blocks of the multiplier according to a preferred embodiment of the present invention.

A temporary register t is used to store the result of the multiplication of the various undersized or part operands in aⱼ and bᵢ. First, the temporary register is cleared to zero. Then, for every i^{%} and j^{%} in the range of 0≦i^{%}, j^{%}≦m/k−1, the following multiplication is performed:

pᵢ_{^{%}}ⱼ_{^{%}}^{(i)(j)}=aᵢ_{^{%}}⁽ⁱ⁾bⱼ_{^{%}}^{(j)}

After each k-bit multiplication, the intermediate 2 k-bit product pᵢ_{^{%}}ⱼ_{^{%}}^{(i)(j)} is added to the product result register t, between bits (i^{%}+j^{%})k and (i^{%}+j^{%}30 2)k−1. This is done for every intermediate 2 m-bit product pᵢⱼ, and the process is thus similar to a “for” loop in the “C” programming language. In order to reduce the read accesses to memory, all values of j are processed before another value of i is used. Alternatively, all values of i are processed before another value of j is used.

The performance of the multiplier for one m-bit subproduct is as follows:

$${Perf}_{bits / cycle} = \frac{m}{( \begin{matrix}2 {t}_{read , m} + {( \frac{m}{k} )}^{2} ( \begin{matrix}{t}_{multiplier , k} + \\ {t}_{add , 2 k}\end{matrix} ) + \\ 2 {t}_{read , m} + 2 {t}_{write , m}\end{matrix} )} = {Perf}_{bits / cycle} = \frac{m}{( \begin{matrix}{( \frac{m}{k} )}^{2} ( {t}_{multiplier , k} + {t}_{add , 2 k} ) + \\ 4 {t}_{read , m} + 2 {t}_{write , m}\end{matrix} )}$$

The above algorithm requires two m-bit registers for each partial operand, and one 2 m-bit register for the partial product pᵢⱼ. Additionally, the algorithm requires a k-bit multiplier, and a 2 k-bit adder.

In the preferred embodiment of the invention, mitigating memory latency is possible by using smaller k and/or larger m values. By using prefetching and delayed writes, memory overhead is completely avoided. This is possible when the time required for calculations is greater than the time required for memory overhead:

$${( \frac{m}{k} )}^{2} ( {t}_{multiplier , k} + {t}_{add , 2 k} ) \geq 4 {t}_{read , m} + 2 {t}_{write , m}$$

$$\frac{m}{k} \geq \sqrt{\frac{4 {t}_{read , m} + 2 {t}_{write , m}}{{t}_{multiplier} + {t}_{add}}}$$

Usually the multiply and add operations have a throughput of one result per cycle. In this case, the condition becomes:

$$\frac{m}{k} \geq ⌈ \sqrt{3} ⌉ = 2$$

The performance without memory overhead is therefore:

$${Perf}_{bits / cycle} = \frac{{k}^{2}}{m ( {t}_{multiplier , k} + {t}_{add , 2 k} )}$$

For the example values of

$$\frac{m}{k} = 2$$

and t_{muliplier,k}=t_{add,2k}=1, the performance is

$${Perf}_{bits / cycle} = \frac{k}{4} .$$

A general purpose processor would achieve much lower performance, due to the data supply overhead. Each k-bit partial product operation would require at least two load instructions to load two k-bit values, one multiply operation, one add operation, one store operation, three instructions for updating the memory pointers and two instructions for flow control. The resulting performance is:

$${Perf}_{bits / cycle} = \frac{k}{2 + 1 + 1 + 1 + 3 + 2} = \frac{k}{10}$$

For an m-bit product, the above computation should be repeated

$${( \frac{m}{k} )}^{2} = 4$$

times for the different k-bit operands, resulting in the following performance:

$${Perf}_{bits \text{/} cycle} = \frac{k}{10 {( \frac{m}{k} )}^{2}} = \frac{k}{40}$$

The following example shows the mathematical operation of the multiplier:

k=2;m=4;a=18=12h;b=72=48h

a⁽¹⁾=1;a⁽⁰⁾=2

a₁⁽¹⁾=0;a₀⁽¹⁾=1;a₁⁽⁰⁾=0;a₀⁽⁰⁾=2;

b⁽¹⁾=4;b⁽⁰⁾=8

b₁⁽¹⁾=1;b₀⁽¹⁾=0;b₁⁽⁰⁾=2;b₀⁽⁰⁾=0;

p_{0,0}⁽⁰⁾⁽⁰⁾=a₀⁽⁰⁾b₀⁽⁰⁾=0·2=0

p_{1,0}⁽⁰⁾⁽⁰⁾=a₁⁽⁰⁾b₀⁽⁰⁾=0·0=0

p_{0,1}⁽⁰⁾⁽⁰⁾=a₀⁽⁰⁾b₁⁽⁰⁾=2·2=4

p_{1,1}⁽⁰⁾⁽⁰⁾=a₁⁽⁰⁾b₁⁽⁰⁾=2·0=0

p⁽⁰⁾⁽⁰⁾=0·2⁴+4·2²+0·2²+2·2⁰=16

p⁽¹⁾⁽⁰⁾=0·2⁴+2·2²+0·2²+2·2⁰=8

p⁽⁰⁾⁽¹⁾=0·2⁴+2·2²+0·2²+2·2⁰=8

p⁽¹⁾⁽¹⁾=0·2⁴+1·2²+0·2²+2·2⁰=4

ab=4·2⁸+8·2⁴+8·2⁴+16·2⁰=1024+128+128+16=1296

### Division Operation

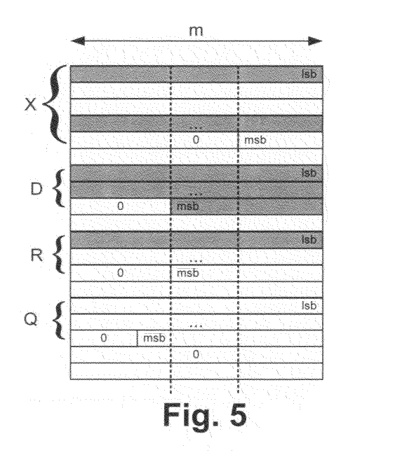

Reference is now made to FIG. 5, which schematically illustrates storage in a memory of the operands X and D, the result R and the quotient Q in a division operation. Division of two large numbers can be a time consuming task. The VLALU implements the division operation by using shift and add operations. First, the most significant bit of the dividend X and the divisor D are found. Afterwards, a sequential division algorithm is used to calculate the quotient q and the remainder r. The division operation is performed in the following manner:

The dividend, the divisor, the quotient and the remainder are divided into single bit variables, as follows:

X={Xₙ_{ₓ}₋₁, . . . , X₁, X₀}

D={Dₙ_{_{d}}₋₁, . . . , D₁, D₀}

q={qₙ_{_{q}}₋₁, . . . , q₁, q₀}

r={rₙ_{ᵣ}₋₁, . . . , r₁, r₀}

The algorithm starts with i=nₓ−n_{d}+1, Y⁽ⁱ⁾={Xₙ_{_{X}}₋₁, . . . , Xₙ_{ₓ}₋ₙ_{_{d}}} Each iteration i of the division consists of three stages, and yields one quotient bit qᵢ. The first stage is a comparison between the dividend and the divisor. If Y⁽ⁱ⁾≦D, the quotient bit qᵢ becomes 1. On the other hand, if Y⁽ⁱ⁾<D, the quotient bit qᵢ becomes 0.

$${q}_{i - 1} = \{ \begin{matrix}1 , & {Y}^{( i )} \geq D \\ 0 , & {Y}^{( i )} < D\end{matrix} \}$$

The second stage of the division is the subtraction stage. In the case of qᵢ=1, the divisor D is subtracted from the dividend Y. However, if qᵢ=0, nothing is done at this stage.

$${X}^{( i )} = \{ \begin{matrix}{Y}^{( i )} - D , & {q}_{i - 1} = 1 \\ {Y}^{( i )} , & {q}_{i - 1} = 0\end{matrix} \} .$$

The third stage of the division is the shifting stage. At this stage, Y⁽ⁱ⁾ is shifted left by one bit, the least significant bit of Y⁽ⁱ⁻¹⁾ becomes Xᵢ₋₂, and i is decreased:

Y⁽ⁱ⁻¹⁾={X⁽ⁱ⁾,X_{i-2}}

After all the bits of X have been shifted into Y, the variable Y⁽⁰⁾ holds the remainder result, r.

r=Y⁽⁰⁾

All versions of Y⁽ⁱ⁾ are stored in a memory structure in the same location. For long operands, a memory structure of m-bit width is used to store the operands. Thus, in the case of long operands, Y⁽ⁱ⁾ may span many m-bit boundaries.

In the preferred embodiment of the invention, the location of the most significant bit of D, Dₙ_{_{d}}₋₁ within the m-bit memory word is the same as the location of the most significant bit of Y⁽ⁱ⁾, as shown in FIG. 5. That is to say, the location of the msb of d and r are identical, since the remainder cannot be larger than d. The co-location is so to avoid the need for shifting the bits of Y⁽ⁱ⁾ for the comparison and subtraction.

In the comparison stage, Y⁽ⁱ⁾ is compared with D. Since the operands may span many m-bit words, more than one cycle may be required to determine the result of the comparison.

The comparison begins with the m most significant bits of Y⁽ⁱ⁾ and D:

$$\begin{matrix}{Y}^{( i )} [ ⌈ \frac{{n}_{d}}{m} ⌉ m - 1 \text{:} ⌈ \frac{{n}_{d}}{m} ⌉ ( m - 1 ) ] = \{ {Y}_{⌈ \frac{{n}_{d}}{m} ⌉ m - 1}^{( i )} , {Y}_{⌈ \frac{{n}_{d}}{m} ⌉ m - 2}^{( i )} , … , {Y}_{⌈ \frac{{n}_{d}}{m} ⌉ ( m - 1 )}^{( i )} \} \\ {D}^{( i )} [ ⌈ \frac{{n}_{d}}{m} ⌉ m - 1 \text{:} ⌈ \frac{{n}_{d}}{m} ⌉ ( m - 1 ) ] = \{ {D}_{⌈ \frac{{n}_{d}}{m} ⌉ m - 1}^{( i )} , {D}_{⌈ \frac{{n}_{d}}{m} ⌉ m - 2}^{( i )} , … , {D}_{⌈ \frac{{n}_{d}}{m} ⌉ ( m - 1 )}^{( i )} \}\end{matrix}$$

If

$${Y}^{( i )} [ ⌈ \frac{{n}_{d}}{m} ⌉ m - 1 \text{:} ⌈ \frac{{n}_{d}}{m} ⌉ ( m - 1 ) ]$$

is larger than

$$D [ ⌈ \frac{{n}_{d}}{m} ⌉ m - 1 \text{:} ⌈ \frac{{n}_{d}}{m} ⌉ ( m - 1 ) ] ,$$

the
quotient bit qᵢ becomes 1. If

$${Y}^{( i )} [ ⌈ \frac{{n}_{d}}{m} ⌉ m - 1 \text{:} ⌈ \frac{{n}_{d}}{m} ⌉ ( m - 1 ) ]$$

is smaller than

$$D [ ⌈ \frac{{n}_{d}}{m} ⌉ m - 1 \text{:} ⌈ \frac{{n}_{d}}{m} ⌉ ( m - 1 ) ] ,$$

the quotient bit qᵢ becomes 0. In case that

$${Y}^{( i )} [ ⌈ \frac{{n}_{d}}{m} ⌉ m - 1 \text{:} ⌈ \frac{{n}_{d}}{m} ⌉ ( m - 1 ) ]$$

is equal to

$$D [ ⌈ \frac{{n}_{d}}{m} ⌉ m - 1 \text{:} ⌈ \frac{{n}_{d}}{m} ⌉ ( m - 1 ) ] ,$$

another comparison will be made for

$${Y}^{( i )} [ ⌈ \frac{{n}_{d}}{m} ⌉ ( m - 1 ) \text{:} ⌈ \frac{{n}_{d}}{m} ⌉ ( m - 2 ) ]$$

and

$$D [ ⌈ \frac{{n}_{d}}{m} ⌉ ( m - 1 ) \text{:} ⌈ \frac{{n}_{d}}{m} ⌉ ( m - 2 ) ] ,$$

and so on. The probability of making another comparison for random numbers is 2^{-m}. Therefore, for every m bits, the comparison requires two loads from memory and a comparator of m bits.

The subtraction stage is performed by subtracting D from Y⁽ⁱ⁾. Since D and Y⁽ⁱ⁾ reside in the same m-word aligned offset in memory, no additional multiplexers are needed. The subtraction may take more than one cycle, depending on the number of m-boundaries within D.

Each shift operation involves reading the next bit out of X, and shifting Y(i) left by one bit. This is done by an m-bit shift register.

In another preferred embodiment of the invention, Y⁽ⁱ⁾ is never shifted, but rather it is stored at discontinuous locations. This embodiment requires that the most significant bits of Y⁽ⁱ⁾ reside in an n_{d}-bit temporary variable in the memory structure, while the least significant bits reside in the original dividend, X. As a result, performance is increased, since no shift is required. However, the increased performance is achieved at the expense of complexity, which results in additional chip area for the comparison and the subtracting stages.

Additional hardware may be used to increase the speed of the divider. In one of the preferred embodiments of the invention, the most significant non zero bit of Y⁽ⁱ⁾ is detected. Then, the shifter parameter s is calculated by the difference between the location of the most significant bit of D and the location of the most significant bit of Y⁽ⁱ⁾. Hardware can be conserved if s is limited to a small value. The shifting is then done using two steps. The first involves reading the s most significant bits of X. This may involve more than one read cycle since these s bits may span more than one m-bit memory word. Then, Y⁽ⁱ⁾ is shifted left, starting at the least significant bits. Depending on the amount of hardware dedicated to the shifter and the parameter s, the shifting for every m-bit word may take a different number of cycles.

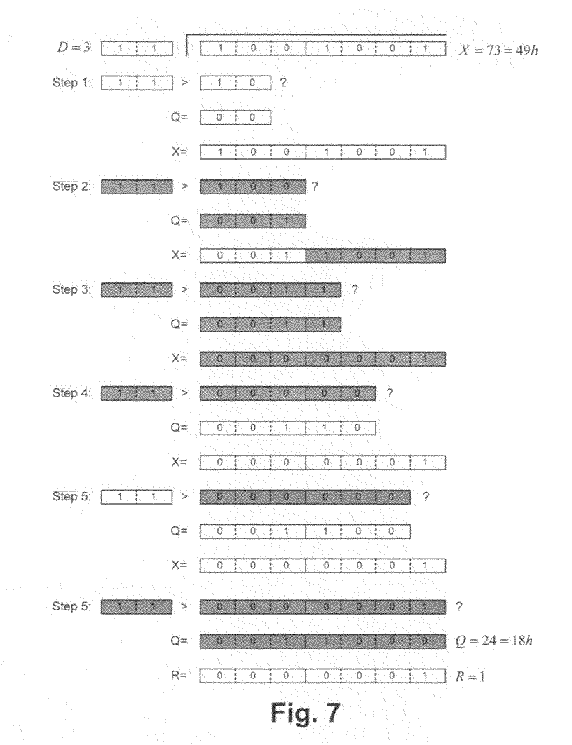

The following example, shown schematically in FIG. 7, shows the mathematical operation of the divider:

m=4;X=73=49h;D=3;

Y⁽⁶⁾=X⁽⁶⁾=X[6..5]={10b}=2

Y⁽⁶⁾<D→q₅=0,X⁽⁶⁾=Y⁽⁶⁾=2

Y⁽⁵⁾={X⁽⁶⁾,X₄}={10b,0b}=4

Y⁽⁵⁾≧D→q₄=1,1,X⁽⁵⁾=Y⁽⁵⁾−D=1

Y⁽⁴⁾={X⁽⁵⁾,X₃}={1b,1b}=3

Y⁽⁴⁾≧D→q₃=1,X⁽⁴⁾=Y⁽⁴⁾−D=0

Y⁽³⁾={X⁽⁴⁾,X₂}={0b,0b}=0

Y⁽³⁾≧D→q₂=0,X⁽³⁾=Y⁽³⁾=0

Y⁽²⁾={X⁽³⁾,X₁}={0b,0b}=0

Y⁽²⁾≧D→q₁=0,X⁽²⁾=Y⁽²⁾=0

Y⁽¹⁾={X⁽²⁾,X₀}={0b,1b}=1

Y⁽¹⁾≧D→q₀=0,X⁽¹⁾=Y⁽¹⁾=1

Y⁽⁰⁾={X⁽¹⁾}=1

q={0,1,1,0,0,0}=24

r=Y⁽⁰⁾=1

Modulo Operation

The modulo operation is executed in a substantially similar method to the division operation above, however, the remainder from the division operation carries the result of the modulo operation.

### Long Arithmetic Logic Unit

In the preferred embodiment of the invention, the long arithmetic unit VLALU shares a temporary register of 2 m bits among its various operations. The operations are therefore mutually exclusive, meaning that only one operation can be performed at any given time.

In another preferred embodiment of the invention, each operation uses its own temporary register and has its own interface to the memory structure. The DMA Controller unit 104 preferably comprises an arbiter to arbitrate access to the memory structure between the various operations. Again, this provides increased performance at the expense of chip area.

The Adder/Subtractor unit 101

The adder/subtractor unit 101 preferably comprises a finite field adder/subtractor of length k, preferably implemented such that it may complete the addition/subtraction operation within a single machine clock cycle. The finite field adder/subtractor unit may receive its operand inputs from, and may deposit its results to, the following options:

Internal shadow or temporary storage.

Shadow or temporary storage of the DMA Controller & Local Storage unit 104.

External memory (via the DMA Controller & local storage unit 104).

Any combination of the above.

The unit may be configured via the Configuration & monitoring interface 110.

### The Multiplier Unit 102

The Multiplier unit 102 may comprise of a finite field multiplier of length k, preferably implemented to complete the multiplication operation within a single machine clock cycle. The multiplier unit may receive its operand inputs from, and deposit its results to, the following options:

Internal shadow or temporary storage.

Shadow or temporary storage of the DMA Controller & Local Storage unit 104.

External memory (via the DMA Controller & local storage unit 104).

Any combination of the above.

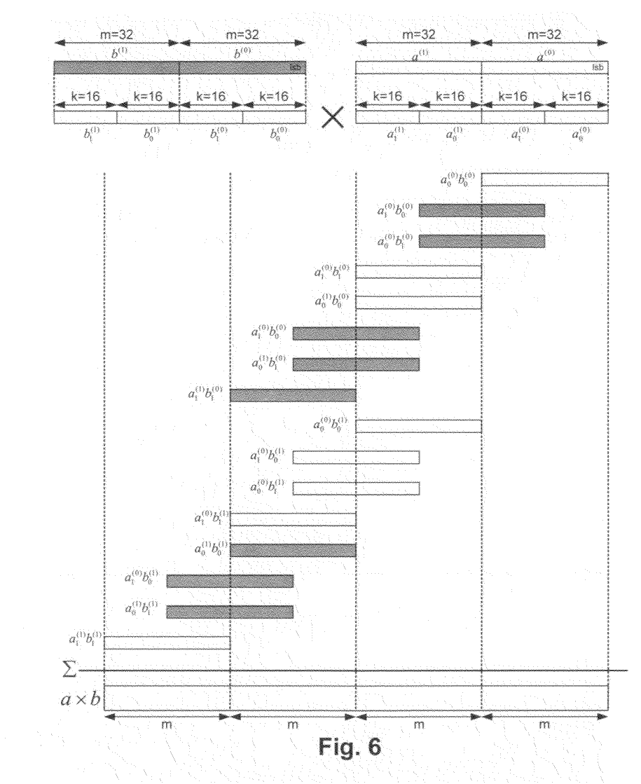

The unit may be configured via the Configuration & monitoring interface 110. FIG. 6 schematically illustrates an example multiplication of two 64 bit operands a and b, when the memory width is 32 bits and the multiplier's width is 16, using the multiplier unit 102.

The Divider/Modulo Unit 103

The Divider/Modulo unit 103 may comprise a finite field adder/subtractor of length k, preferably implemented such that it may complete the subtraction operation within a single machine clock cycle. The divider/modulo unit may receive its operand inputs from, and deposit its results to, the following options:

Internal shadow or temporary storage.

Shadow or temporary storage of the DMA Controller & Local Storage unit 104.

External memory (via the DMA Controller & local storage unit 104).

Any combination of the above.

The unit may be configured via the Configuration & monitoring interface 110. FIG. 7 illustrates the use of unit 103 to carry out the operation of dividing 73 (49h) by 3.

### Direct Memory Access (DMA) Controller & Local Storage 104 Unit

Asymmetric encryption and decryption usually involve operations such as multiplication and division with large operands. These operands may comprise thousands of bits each, making it impractical to store such large operands in internal registers in an area-constrained design. Therefore, the VLALU device 100 preferably fetches its operands from a random access memory, as well as from a smaller register array.

The VLALU device 100 may access data stored in external memory using an internal or external DMA controller, such as DMA Controller & Local Storage unit 104. The addresses of the operands are provided to the DMA controller, and subsequently, the data are fetched from the external memory and provided to the VLALU. The operands are then stored into the Local Storage 104, or into internal registers of the Adder/Subtractor 101, Multiplier 102, Divider/Modulo 103 respectively. Storing is done in the same manner, i.e., internal or external DMA controller is provided with the target address, and the output of the Adder/Subtractor 101, or Multiplier 102, or Divider/Modulo 103, or the content of the Local Storage 104 is stored in the external memory.

Such a DMA controller may comprise input and output FIFO (first-in, first-out) memory, efficient arbitration and bus mastering capabilities and the like.

An example of a memory allocation for storing of m bit data words is provided in FIG. 2 referred to above. This figure further depicts the location of three arbitrary size operands in storage.

The skilled in the art may appreciate that the VLALU device 100 may perform one or more of the operations below, in parallel:

Adding two long operands.

Subtracting two long operands.

Multiplying two long operands.

Dividing two long operands.

Finding the modulus of two long operands.

Fetching operands from local or external storage.

Storing results to local or external storage.

Any combination of the above.

A VLALU device as described above is highly useful for cryptography operations of the kind described above.

It is expected that during the life of this patent many relevant devices and systems will be developed and the scope of the terms herein, particularly of the terms cryptology, compression, accumulator, multiplier, divider, adder, subtractor, ALU and modulo are intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents, and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. An arithmetic and logic unit for carrying out arithmetic or logic operations on long operands, said long operands having an operand word length, the unit comprising:
an operation unit comprising circuitry for carrying out selectable ones of a plurality of pre-defined arithmetic or logical operations on a first number of bits determined by said operand word length;
a fetch and write unit comprising direct memory access circuitry for fetching a second number of bits of operand data by direct access from an external memory and for writing results to memory, said second number being set by a predetermined memory access width;
said second number being smaller than an operand length, and said fetch and write unit being controllable to carry out fetch operations for a further second number of bits of a long operand while a current part of said operand is being processed in said operation unit, thereby to hide memory access latency.

2. The unit of claim 1, wherein said first predetermined number is selected with respect to said operand word length such that a time required for respective predefined arithmetic or logical operations is greater than the time required for memory fetch and write operations.

3. The unit of claim 2, wherein said first predetermined number is selected to optimize between chip area utilization, said time required for fetch and write operations and power utilization.

4. The unit of claim 1, wherein one of said predetermined operations is addition and said fetch and write unit is controllable in the case of addition to fetch each second predetermined number of bits of a current operand prior to processing, said unit further comprising at least two prefetch registers each to store a respective instance of said second predetermined number of bits until required for processing.

5. The unit of claim 1, wherein one of said predetermined operations is multiplication, and wherein said fetch and write unit is controllable in the case of multiplication to fetch said second predetermined number of bits of each of two multiplication operands, and to complete multiplication sub-operations on all bits of one of said two multiplication operands before fetching new bits of the other of said two multiplication operands.

6. The unit of claim 1, further comprising a single temporary register shared between all of said plurality of arithmetic or logical operations.

7. The unit of claim 1, further comprising a plurality of dedicated temporary registers for respective ones of said plurality of arithmetic or logical operations.

8. The unit of claim 7, further comprising a direct memory access arbiter for arbitrating between said respective ones of said plurality of arithmetic or logical operations to dynamically assign direct memory access to said respective operation.

9. A multi-word arithmetic device for executing modular arithmetic on multi-word integers, in accordance with instructions from an external device, the multi-word arithmetic device comprising:
a memory;
an arithmetic unit for executing, on word units, at least four types of word calculations, including addition, subtraction, multiplication, comparison and shifting, and outputting a one-word calculation result;
a memory input/output circuit for performing (1) a first data transfer for storing in the memory at least one integer received from an external device, (2) a second data transfer for inputting at least one integer stored in the memory into the arithmetic unit in word units, (3) a third data transfer for storing in the memory the calculation result output from the arithmetic unit, and (4) a fourth data transfer for outputting the calculation result from the memory to the external device; and
a control circuit for, according to instructions received from the external device,
(a) specifying, to the memory input/output unit, data to be transferred by the second and third data transfers, and
(b) specifying, to the arithmetic unit, a type of word calculation to be executed,
thereby controlling:
(i) the arithmetic unit to selectively perform one of said at least four types of calculations, including addition, subtraction, multiplication and division, on the at least one integer stored in the memory; and
(ii) the memory input/output circuit to store the calculation result of the calculations into the memory,
wherein the selected modular arithmetic includes a plurality of word calculations, each word calculation for a different word of the at least one integer;
the control circuit being configured such that when the selected modular arithmetic is performed, the control circuit repeatedly instructs, for each word of the at least one integer, the arithmetic unit to perform the word calculation,
wherein, when receiving an instruction to execute calculations from the external device, the control circuit controls the memory input/output circuit and the arithmetic unit so as to execute the following processing:
(1) the memory input/output circuit acquires the operands for the calculations from memory;
(2) the arithmetic unit computes partial results for words from each of (i) parts of the operands, and (ii) the result integer;
(3) the memory input/output circuit stores the result of (2) in memory.

10. The multi-word arithmetic device of claim 9 wherein, in processing (2), the arithmetic unit selects sets of word pairs, each set formed from all the pairs of words that generate a partial result with a same digit position, sets input values in the multiplier, adder, subtractor, comparator or shifter, and computes the partial result for the selected pairs of words.

11. The multi-word arithmetic device of claim 10, wherein, the arithmetic unit is configured to store in the memory as part of a multiplication result a lower word from a two-word accumulated result obtained by accumulating partial products with the same digit position, and to add an upper word from the accumulated result to partial products that have a digit position one word higher and are thus the next to be calculated.

12. The multi-word arithmetic device of claim 11, wherein the arithmetic unit is configured to store a lower word from the accumulated result in the memory simultaneously with an operation for adding an upper word from the accumulated result to partial products that have a digit position one word higher and are thus the next to be calculated.

13. The multi-word arithmetic device of claim 12 wherein, when computing and accumulating partial products in processing (2) for multiplication, the arithmetic unit is configured to update accumulated values by
(a) simultaneously (i) computing a partial product and (ii) reading a previously accumulated one-word value from the memory,
(b) adding the accumulated one-word value to a corresponding word in the partial product, and
(c) storing a result of the addition in a corresponding area of the memory.

14. The multi-word arithmetic device of claim 9, wherein, when computing addition or subtraction in processing (2), the arithmetic unit is configured to calculate and propagate the carry from the addition or subtraction operation of two words to the next two words.

15. The multi-word arithmetic device of claim 9 wherein, when computing division in processing (2), the arithmetic unit uses comparisons and shifts.

16. An arithmetic and logic unit for carrying out arithmetic or logic operations on long operands having an operand word length, the unit comprising:
an operation unit comprising a processing location, the operational unit being configured for carrying out processing on bits at said processing location, the processing comprising selectable ones of a plurality of pre-defined arithmetic or logical operations, the processes being defined for a first number of bits determined by said operand word length;
a fetch and write unit comprising direct memory access circuitry for fetching a second number of bits of operand data by direct access from an external memory and for writing results to memory, said second number being set by a predetermined memory access width;
said second number being smaller than or equal to said first predetermined number, and said direct memory access circuitry being configured to deliver said second number of bits directly to said processing location.

17. The unit of claim 16, wherein said fetch and write unit is controllable to carry out fetch operations for a further second number of bits of a long operand while a current part of said operand is being processed in said operation unit, thereby to hide memory access latency.

18. An arithmetic and logic unit for carrying out arithmetic or logic operations on long operands having an operand word length, the unit comprising:
an operation unit comprising a processing location, the operational unit being configured for carrying out processing on bits at said processing location, the processing comprising selectable ones of a plurality of pre-defined arithmetic or logical operations, the processes being defined for a first number of bits determined by said operand word length;
a fetch and write unit comprising direct memory access circuitry for fetching a second number of bits of operand data by direct access from an external memory and for writing results to memory, said second number being set by a predetermined memory access width and being smaller than said first number;
and wherein said operation unit comprises a dedicated register for each one of said plurality of predefined arithmetic or logical operations, thereby to allow more than one of said plurality of predefined arithmetic or logical operations to be carried out in parallel.

19. The apparatus of claim 18, wherein said fetch and write unit comprises separate memory interfaces for each of said plurality of operations.
